(19) United States
(12) Patent Application Publication
(10) Pub. No.: US 2003/0215638 A1
(43) Pub. Date: Nov. 20, 2003

(54) Reduced symmetry nanoparticles

(75) Inventors: Clarence Charnay, Montpellier (FR); Nancy J. Halas, Houston, TX (US); Robert Kelley Bradley, Houston, TX (US)

Correspondence Address: CONLEY ROSE, P.C., P. O. BOX 3267, HOUSTON, TX, 77253-3267, US

(73) Assignee: Wm. Marsh Rice University, Houston, TX

(21) Appl. No.: 10/404,759

(22) Filed: Apr. 1, 2003

Related U.S. Application Data
(63) Continuation-in-part of application No. 10/012,791, filed on Nov. 5, 2001.
(60) Provisional application No. 60/369,251, filed on Apr. 1, 2002.

(51) Int. Cl. B32B 5/16

(52) U.S. Cl. 428/403; 428/900; 427/222

(57) ABSTRACT

Methods and apparatus for providing nanoparticles having reduced symmetry are disclosed. One embodiment of a preferred method for producing such nanoparticles includes functionalization of a nanoparticle core, partial chemical passivation or masking of the nanoparticle surface, and nucleation and deposition of colloidal particles to selectively coat a specific section of the nanostructure surface with a conducting material.

### CROSS-REFERENCE TO RELATED APPLICATIONS

This application is a continuation-in-part of U.S. patent application Ser. No. 10/012,791 filed Nov. 5, 2001, and also claims the benefit of U.S. Provisional Application No. 60/369,251 filed Apr. 1, 2002. The disclosures of those applications are incorporated herein by reference.

### STATEMENT REGARDING FEDERALLY SPONSORED RESEARCH OR DEVELOPMENT

Not applicable.

### FIELD OF THE INVENTION

The present invention generally relates to the field of metal nanostructures. More specifically, the present invention relates to metal nanoparticles having reduced symmetry for use in plasmonics.

### BACKGROUND OF THE INVENTION

Metal nanostructures have been studied extensively in the field of nanoscience, where “nano” is loosely defined as small, typically in the range of microns or smaller. Nanostructures' robust synthetic and functionalization chemistry, in combination with their interesting physical properties, make them ideal structures for fundamental research and applications. In particular, nanostructures made from noble metals, (e.g. Au and Ag) with their associated strong plasmon resonance have generated great interest. The fact that the plasmon response is a sensitive function of nanostructure geometry, coupled with synthetic advances that allow for controlled and systematic variations in nanostructure geometries, is leading to a dramatic increase in interest in this topic. This renaissance is resulting in a new field called “plasmonics,” associated with the design and fabrication of nano-optical components that focus and manipulate light at spatial dimensions far below the classical diffraction limit. New applications of plasmonics, such as metal nanostructure-based strategies for chemical sensing, electromagnetic wave transport, and the development of new optically responsive materials have recently been reported. This is also stimulating an increased theoretical interest in the electronic and electromagnetic properties of nanoscale metal structures.

From the variety of nanoscale geometries that have stimulated interest in plasmonics, a particular geometry of significant practical interest is a nanoshell: a metallodielectric nanoparticle where Au or Ag forms a uniform shell around a dielectric core. It has been shown that metallodielectric, core-shell nanoparticles possess a tunable plasmon resonance that can be controlled by changing the ratio of the core radius to the shell thickness. The core/shell ratio of a nanoshell controls its far field optical properties, so that its color can be tuned across the electromagnetic spectrum. It also controls the intensity of the optical field at the surface of the nanoparticle, enabling the control and optimization of Raman scattering enhancements at the nanoshell surface. For Au-silica nanoshells, the nanoshell particle is constructed by first attaching small gold colloidal particles onto the surface of a silica core. This is followed by the reduction of gold from solution onto the core utilizing the chemisorbed gold colloidal particles as nucleation sites. The resulting nanoshell possesses a frequency-agile plasmon resonance that can be tuned from the visible to the infrared region of the electromagnetic spectrum. Several other methods for the synthesis of core-shell nanostructures have been reported, which include growth of a metal shell onto core materials other than silica, variations in reductant chemistry, and the synthesis of hollow crystalline shells by templating on block copolymers.

While a number of methods exist for producing nanoparticles having a core and shell, methods for producing nanoparticles having reduced symmetry, i.e. asymmetric geometry, are not known to exist. Because changing the geometry of nanoparticles is known to affect the plasmon resonance, it is contemplated that nanoparticles having reduced symmetry may give rise to new plasmonic devices and applications.

### SUMMARY OF THE INVENTION

The present invention relates generally to nanostructures, such as nanoparticles or nanoshells. More particularly, the present invention provides for methods and apparatus for producing nanoparticles having reduced symmetry.

One embodiment of a preferred nanostructure comprises a nanoparticle having approximately 70-80% metal coverage, herein defined as a “nanocup particle” or “nanocup.”

Another embodiment of a preferred nanostructure comprises a nanoparticle having approximately 20-30% metal coverage, herein defined as a “nanocap particle” or “nanocap.”

A preferred method for producing such nanoparticles includes functionalization of a nanoparticle core, partial chemical passivation or masking of the nanoparticle surface, and nucleation and deposition of colloidal particles to selectively coat a specific section of the nanostructure surface with a conducting material. Preferred core materials comprise dielectric materials such as silica, titania, polymethyl methacrylate (PMMA), polystyrene, gold sulfide and macromolecules (e.g. dendrimers) and semiconducting materials such as CdSe, CdS and GaAs. Generally, the conducting material is metallic but it may also be an organic conducting material such as polyacetylene, doped polyanaline and the like. Suitable metals include the noble and coinage metals but any metal that can conduct electricity is suitable. Metals that are particularly well suited for use include gold, silver, copper, platinum, palladium, lead, iron, nickel or the like. Gold and silver are preferred. Alloys or non-homogenous mixtures of such metals may also be used.

The present invention comprises a combination of features and advantages that enable it to substantially improve the application of nanoparticles. In addition to nanocups and nanocaps, it is contemplated that nanoparticles having between 10-90% metal coverage may be produced by methods in accordance with the present invention. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a schematic representation of the fabrication of reduced symmetry in accordance with a first embodiment of the present invention;

FIG. 2 is a schematic representation of the fabrication of reduced symmetry in accordance with a second embodiment of the present invention;

FIGS. 3a and 3b are SEM images of gold nanocup particles at different resolutions;

FIGS. 4a and 4b are SEM images of silica particles embedded in a masking polymer (a) before and (b) after the growth of the gold nanocap;

FIG. 5 is a schematic representation of sample collection geometry;

FIGS. 6a-6c are theoretical calculation models of the near infield optical intensity of nanocup particles;

FIGS. 7a-7c are angle-dependent nanocup particle extinction spectra;

FIGS. 8a-8c are theoretical calculation models of the near infield optical intensity of nanocap particles;

FIGS. 9a-9c are angle-dependent nanocap particle extinction spectra;

FIGS. 10a and 10b are normal incidence extinction spectra (a) calculated for nanocaps and (b) a theoretical fit to the experimental normal incidence spectrum of FIG. 7a; and

FIG. 11 shows variety of complex reduced symmetry nanostructures made in accordance with the present invention.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of certain elements may be omitted in the interest of clarity and conciseness.

The present invention relates to methods and apparatus for producing nanoparticles having reduced symmetry. Further, the optical response of these nanostructures as a function of their orientation dependence with respect to the angle of light incidence and polarization will be discussed. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results.

The present nanoparticles are preferably fabricated by (i) functionalization of a nanoparticle core; (ii) partial chemical passivation or masking of the nanoparticle surface; and (iii) nucleation and deposition of colloidal particles to selectively coat a specific section of the nanostructure surface with conducting material. Nanoparticles made in accordance with principles of the present invention are typically between 1 nm and 5 μm in size (diameter).

Functionalization of a Nanoparticle Core

Monodispersed silica particles are preferably used as the cores in the preparation of gold asymmetric nanoparticles. The silica particles are synthesized according to the Stober method, which is described in U.S. Pat. No. 6,344,272, incorporated herein by reference in its entirety. Following synthesis, the surface of the silica particles is functionalized with 3-aminopropyltrimethoxysilane (APTS) using methods known in the art. Particle size distributions may be measured from multiple transmission electron microscope (TEM) images using a JEOL JEM-2010 TEM. Dynamic light scattering (DLS) may also be used to determine particle size distribution. Silica particle solutions are preferably diluted before use by adding 500 μl of the particle suspension to 20 mL of ethanol. Aqueous solutions of small gold colloidal particles (2-3 nm in diameter) are prepared by the reduction of chloroauric acid with tetrakishydroxymethylphosphonium chloride (THPC) as known in the art.

Chemical Passivation or Masking

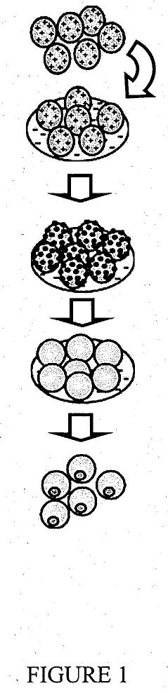

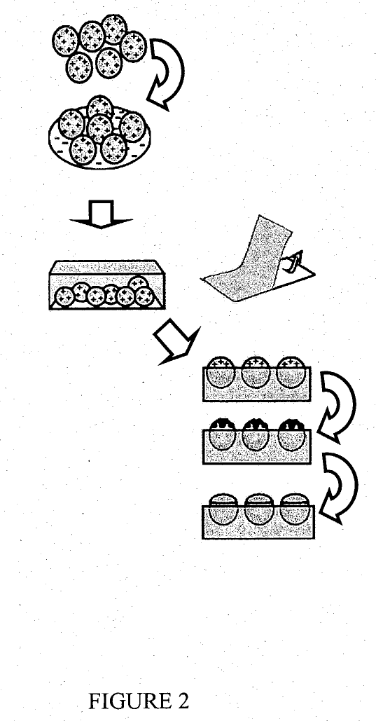

Nanoparticles possessing a reduced symmetry geometry were prepared by adapting the procedure used for the preparation of silica core/gold nanoshells as disclosed in U.S. Pat. No. 6,344,272. The synthesis of these geometrically and chemically asymmetric particles is accomplished by masking one or more parts of the particle surface to avoid the formation of a complete spherical gold shell. The process for the preparation of silica particles with asymmetric gold shells is illustrated in FIGS. 1 and 2. As shown in FIGS. 1 and 2, a portion of the core particle surface is masked; the amine-functionalized silica particles are deposited onto a masking substrate that covers the particle surface in contact with the masking substrate. The particular masking geometry (i.e. glass slide) shown in FIG. 1 limits the overall surface area of the particle that can be masked. In order to increase the masked surface area, the deposited particles may be embedded in a polymer matrix such as that shown in FIG. 2.

Nucleation and Deposition of Colloidal Particles

Gold colloidal particles are attached to the exposed silica particle surface via coupling with the amine functionality of the 3-aminopropyltriethoxysilane attached to the silica particle surface. Next, growth of the desired gold shell by chemical reduction of gold hydroxide is achieved using a reductant such as formaldehyde. It has been demonstrated in U.S. Pat. No. 6,344,272 that the adsorbed gold colloidal particles act as nucleation sites for the gold salt reduction onto the silica core particle. In an exemplary embodiment, the gold shell growth proceeds by mixing 50 μL of a formaldehyde solution (37% wt.) to 25 mL of a stock gold solution (3.5 mM HAuCl₄, 1.75 mM K₂CO₃).

Nanoparticles having reduced symmetry, which affect the plasmon resonance of the nanostructures, are provided. The nanoparticles include a core and a conducting shell, wherein the shell provides between approximately 10-90% coverage. As described above, nanocups have between 70-80% metal coverage, while nanocaps have between 20-30% metal coverage. Exemplary nanocups and nanocups prepared according to the present methods are described below.

### EXAMPLE 1

### Nanocup Preparation

To begin preparing metal nanocups, APTS-functionalized silica particles or cores were first deposited onto a negatively charged glass slide (masking substrate) from an aqueous solution at a pH of 4. Without wishing to be bound by any particular theory, it is believed that maintaining a solution pH of 4 keeps the particles isolated on the masking substrate during deposition. In this step the glass slide was kept in the diluted suspension for about 5 minutes, then removed and gently washed with water. The exposed surface of the particles was then coated with gold colloidal particles by immersing the slide in the gold colloid solution for about 4 hours. The small gold colloidal particles have a high affinity for the functionalized silica particles; the gold colloidal particles attach to the amine functional groups. The glass slide was then removed from the gold colloid solution and washed with water. Growth of the gold nanocup on the exposed part of the gold-decorated silica surface was accomplished by immersing the glass slide (with silica particles) into the stock gold solution followed by the addition of the reducing agent. The reduction step was repeated until the glass slide became blue-green in color, indicating the formation of the gold nanocups. Between each gold reduction reaction the glass slide was washed with water.

The plasmon response of nanocups obtained in this manner was studied without removing the nanoparticles from the masking substrate, in order to preserve the nanoparticle orientation inherent in the fabrication process.

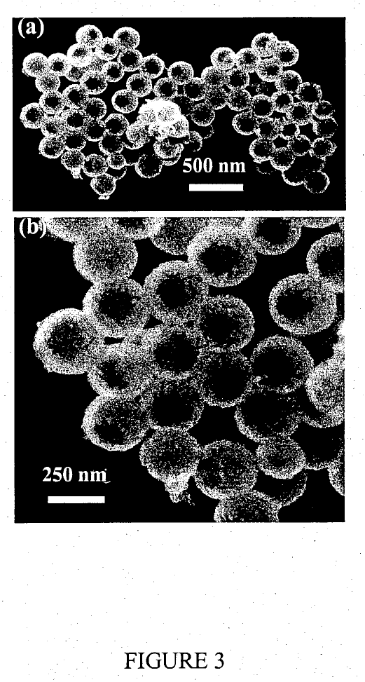

The nanocup particles were then removed from the masking substrate using probe sonication and dispersed in a suitable solvent such as water, ethanol, or DMF. After removal from the substrate, the nanocup particles were characterized using scanning electron microscopy (SEM). FIGS. 3a and 3b are SEM images showing that each nanoparticle has a well-defined and uniform dark area where no gold has been reduced. This area corresponds to the region of the nanoparticles that had been covered by the masking substrate.

### EXAMPLE 2

### Nanocap Preparation

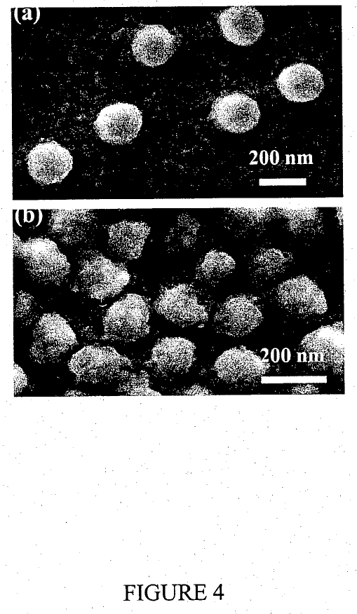

The preparation of nanocap particles follows the same initial silica particle deposition onto a negatively charged glass slide used in preparing nanocups. After washing and drying the glass slide, polydimethylsiloxane (PDMS) elastomer was poured over the particles and left to stand for about 6 hours at 323° K, allowing the elastomer to cure. The PDMS matrix had a typical thickness of about 1 mm. Upon removing the PDMS film from the glass slide, it was observed that the silica particles were pulled off of the glass slide and retained in the PDMS matrix. As shown by a SEM image (FIG. 4a), the silica particles were partially embedded in the PDMS and only a small part of their surface was exposed. In this way most of the silica particle surface is masked and cannot react under further processing. In order to attach the gold colloidal particles to the exposed surface of the silica particles, the PDMS film with the embedded silica particles was submersed in gold colloid solution for 48 hours. Once the gold colloidal particles were attached, gold nanocap particles were obtained using the same reduction process as described for nanocups.

FIG. 4b also shows an SEM image of gold-capped silica nanoparticles at the surface of the PDMS film. The surface of gold nanocaps appears rough in comparison to the embedded silica particles of FIG. 4a. This roughness is characteristic of a metallic film that is chemically deposited. The gold nanocap arises from the growth of the previously adsorbed gold colloidal particles, which are used as nucleation sites during the reduction process. The size of these gold colloidal particles increases until they coalesce and form a continuous metallic structure. A size distribution of nanocaps from 20 nm to 90 nm in diameter was observed. The observed size distribution results from different parameters associated with the preparation that will be discussed below. In order to measure the orientational dependent plasmon response of nanocaps, the particles were not removed from the elastomer film so as to preserve their structure and orientation on the substrate.

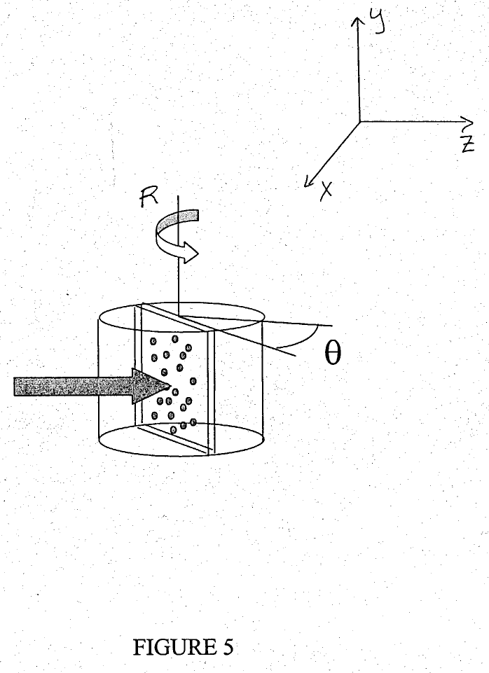

In order to better characterize nanoparticles made in accordance with the present invention, the optical spectra of nanocups and nanocaps were measured as a function of nanoparticle orientation with respect to incident p- and s-polarized light. The experimental geometry is shown in FIG. 5. For this geometry, p-polarized light is defined with the electric field vector E orthogonal to the axis of rotation R of the measurement cell (i.e. p-polarized light is in the x-y plane), and for s-polarized light the electric field vector E is parallel to the axis of rotation R of the measurement cell (i.e. s-polarized light is in the y-z plane). The output of a halogen lamp was focused into a 0.25 meter monochromator and polarized using a cube polarizer. The transmission spectra of the masked nanoparticles were measured using a silicon photodiode detector and standard lock-in techniques. The samples were mounted inside a cylindrical glass cell containing uncured liquid PDMS elastomer to achieve index matching between the sample masking substrate and the walls of the cylindrical cell. A cured PDMS film was used as a reference. The extinction spectra of nanocups and nanocaps measured using p-polarized light were normalized for comparison. Extinction spectra are herein defined as optical transmission spectra measuring the total light, which is both absorbed by and scattered from the sample. Normalization was made with respect to the peak intensity at 680 nm of a nanoparticle-embedded PDMS film measured using p-polarized light.

As stated above, changing the geometry of nanoparticles is known to affect the plasmon resonance. Specifically, it is contemplated that the plasmon response becomes a sensitive function of the orientation of the nanostructure with respect to incident light, wherein both the plasmon frequency and the cross section of the response show strong and dramatic orientation dependence. This unique property should make possible the orientation and manipulation of these nanostructures by applied electric and electromagnetic fields, which in turn should give rise to new plasmonic devices and applications.

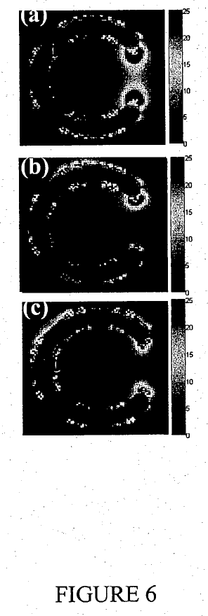

Referring now to FIG. 6, the near field optical intensities (|E|²) for gold nanocups as calculated using a three-dimensional finite difference time domain (FDTD) numerical method developed for the study of plasmonic nanostructures are shown. In FIG. 6, the near field distribution of a nanocup under resonant illumination for a range of orientations (FIG. 6a: θ=0°, λ=600 nm; FIG. 6b: θ=40°, λ=600 nm; and FIG. 6c: θ=80°, λ=600 nm) under p-polarized optical illumination is shown. The cross sectional plane corresponds to both the plane of polarization and the plane of incidence: for FIG. 6a the light is incident from the left and for FIGS. 6b and 6c the angle of incidence increases in the clockwise direction. The basic characteristics of a nanocup plasmon are readily apparent from this calculation, wherein the highest field intensities are located at the metal cup edges. Thus, by varying the angle with respect to incident light, the relative strength of the field along the metal cup edge is varied. This is seen most dramatically in FIG. 6b where, for 40° excitation the field intensity at the nearest edge of the nanocup is much greater than that at the far edge with respect to the direction of incidence. The plasmon response in both the near and far field is very similar whether the nanocup edge is facing the incident light or is opposite to the incident light, or rotated 180° from the source (not shown). However, when the nanocup orientation is rotated from normal incidence (FIG. 6a) to side incidence (FIG. 6c), the plasmon response is noticeably blue-shifted.

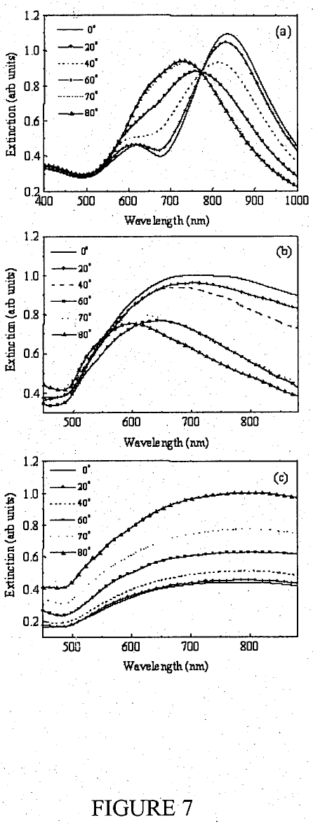

The far field extinction spectra for gold nanocups as this orientation angle is changed are shown in FIG. 7. FIG. 7a shows the theoretically calculated extinction spectra for gold nanocups with a core radius r=50 nm, a gold thickness t=20 nm, and hole diameter h=50 nm. The large peak centered at 830 nm corresponds to the long-axis dipolar plasmon resonance and the peak centered at 725 nm corresponds to the short-axis plasmon resonance. The small peak at 610 nm for small angles is a quadrupole resonance. FIG. 7b shows the experimental extinction spectra obtained using p-polarized light as the irradiation angle θ varies. Agreement with the theoretically predicted spectra in FIG. 7a is not quantitative, but qualitatively a very similar angle-dependent frequency shift (˜100 nm) in the plasmon response is clearly seen as the nanocup orientation is rotated from normal to side incidence. At normal incidence, θ=0°, the extinction spectrum exhibits a broad peak centered at approximately 700 nm. As the incident angle is increased, the intensity of this extinction peak decreases, and the peak position is blue shifted. At θ=80°, the peak has shifted to nominally 600 nm.

Without wishing to be bound by any particular theory, it is believed that the discrepancies between the theoretical and experimental plasmon response are most likely attributable to the inherent roughness of the gold nanocup surface; the theoretical model used assumes a perfectly smooth shell whereas a rough or porous shell would be expected to broaden the plasmon resonance, provide a smaller wavelength shift, and smooth out any multipolar features that may be present, specifically the appearance of the quadrupolar resonance. FIG. 7c shows the experimental extinction spectra for nanocups using s-polarized light. For this polarization orientation there should be no angle dependence in the optical response of the nanostructures, since the electric field (E field) of the incident wave is parallel to the axis of rotation and therefore does not change in orientation as the nanocup angle is changed. As θ is increased, no spectral shift is observed, however, the extinction intensity increases with increasing sample angle because a greater number of nanostructures are being illuminated within the optical beam with increasing angle.

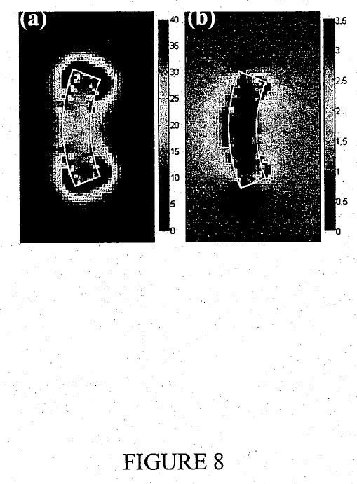

Referring now to FIG. 8, the near field optical intensities (|E|²) for gold nanocaps as calculated using a three-dimensional finite difference time domain (FDTD) numerical method are shown. A cross sectional slice of a nanocap is shown, and both the electric field vector (E) and the wave vector of the incident light (k) are in the plane of FIG. 8. For FIG. 8a light is incident from the left (θ=0°, λ=686 nm), and for FIG. 8b light is incident from below (θ=90°, λ=515 nm). Under these two excitation directions, two plasmon modes are selectively excited: a longer wavelength longitudinal plasmon as seen in FIG. 8a and a shorter wavelength transverse plasmon mode shown in FIG. 8b. The presence of polarization dependent longitudinal and transverse plasmon frequencies is also seen in nanorods and other elliptical nanostructures (not shown).

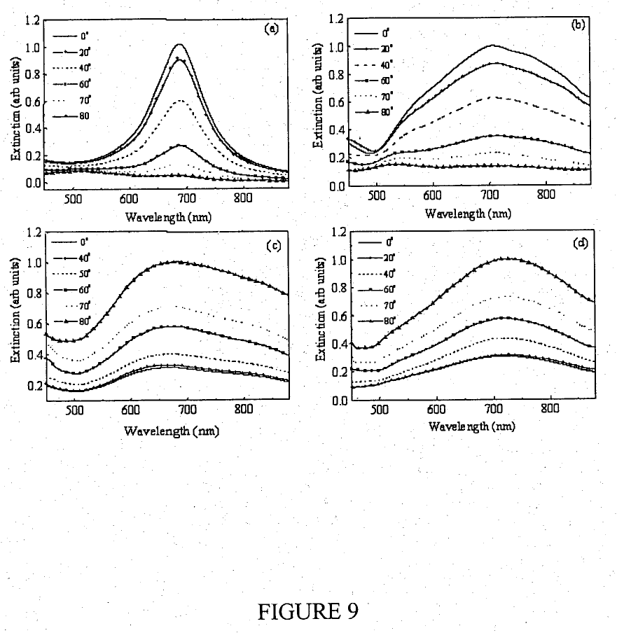

In FIG. 9, the theoretical and experimental extinction spectra for gold nanocaps are shown, and the longitudinal and transverse plasmon excitations are apparent. For normal incidence, only the longer wavelength longitudinal mode is excited. However as the particle is rotated beyond 45°, the smaller wavelength, smaller amplitude, and transverse plasmon begins to appear. In both theory and experiment, the extinction spectra decrease as the orientation of the nanocap is rotated from normal incidence to sideways incidence. Also, the extinction cross-section for sideways incident excitation is dramatically smaller than for normal incidence.

FIG. 9a shows the theoretical extinction spectra of a gold nanocap with a cap size d=55 nm, a core radius r=50 nm, and a cap thickness t=12.5 nm, at various incident angles under p-polarized incident light. The theoretical spectra exhibit both a longitudinal plasmon resonance peak at 688 nm and a transverse plasmon resonance peak at 512 nm, which appears at larger angles. Moreover, the extinction intensity ratio of the transverse plasmon resonance relative to the longitudinal plasmon resonance increases with increasing incident angle. FIG. 9b shows the experimental extinction spectra for oriented gold nanocaps. At normal incidence, θ=0°, the extinction spectrum exhibits a broad peak with a maximum at 708 nm, due to excitation of the longitudinal plasmon. As the incident angle increases, the intensity of this peak is consistently reduced until there is almost no extinction at θ=80°. At angles greater than θ=60°, a peak in the extinction spectrum at 540 nm, the shorter wavelength transverse plasmon, begins to appear. As the incident angle is increased, the ratio of the extinction intensity of the transverse plasmon resonance compared to the longitudinal plasmon resonance increases. As the angle is varied from 60° to 80°, this ratio changes from 0.65 to 1.11. Except for the extinction bandwidth, there is a good qualitative agreement between the calculated and experimental extinction spectra: all major features (i.e. longitudinal and transverse plasmon excitations) are readily observable. As with nanocups, the theory assumes a perfectly smooth gold cap while the synthesis results in structures with a nanoscale roughness (FIG. 4b). For nanocaps, the plasmon linewidth is also broadened inhomogeneously due to the size distribution of the fabricated nanocaps. The effect of this size distribution will be discussed below.

In FIGS. 9c and 9d, two important control experiments that illustrate the difference in optical response between nanocaps and nanoshells are given. FIG. 9c shows the changing extinction spectra of a sparse, PDMS-embedded nanoshell film under p-polarized light as the incident angle θ is varied. The nanoshells were synthesized by a standard method and subsequently deposited onto a glass slide so that their plasmon response could be compared directly to nanocups and nanocaps. For the case of the spherically symmetric nanoparticles or nanoshells, angular dependence in the plasmon extinction spectrum is not observed. The extinction increases with increasing angle, in similarity with the nanocup plasmon response, since at greater angles, more nanoshells enter the beam spot of the experiment. For both nanoshells and nanocups, the inverse cosine angle dependence of the extinction amplitude is observed and as the incident angle increases, the number of nanoshells or nanocaps being irradiated increases. However, in nanocaps the angular response decreases with increasing angle of orientation. FIG. 9d shows the extinction spectra of nanocaps under s-polarized light as the incident angle θ varies. The spectral features of the nanocap plasmon response under s-polarized light exhibit no angular dependence other than a changing intensity. However, in comparison with the p-polarized excitation of FIGS. 9a and 9b, the extinction intensity in FIG. 9d increases with increasing incident angle.

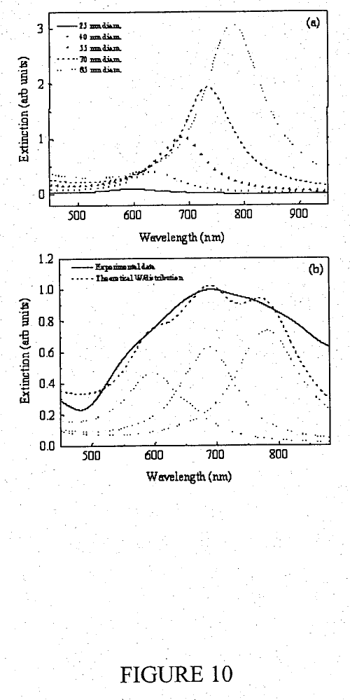

For nanocaps, the spectral widths of the experimental extinction spectra are substantially broader than the peaks in the corresponding theoretical spectra. This discrepancy can be accounted for if the experimentally fabricated nanocaps are assumed to exhibit a significant size distribution (FIG. 10). Variations in the amount that the silica cores protrude from the PDMS masking layer result in a broad distribution of nanocap diameters, even when the silica nanoparticle cores are highly monodisperse. The size distribution of the core silica nanoparticles is preferably less than 5%.

Moreover, atomic force microscopy (AFM) images support the conclusion that the thickness of the gold cap is well defined and is nearly homogeneous over the entire nanocap sample. This homogeneous deposition of the nanoshell layer has also been inferred from plasmon linewidth studies of silica-gold nanoshells, such as described in S. L. Westcott, J. B. Jackson, C. Radloff, and N.J. Halas “Relative Contributions to the Plasmon Lineshape of Metal Nanoshells”, Phys. Rev. B, 66, 155431 (2002). The heterogeneity of the nanocap diameters that results in the observed broadening of the nanocap plasmon linewidth relative to the theoretical predictions is believed to be mainly a consequence of the cap radius distribution rather than a cap thickness distribution.

It is recognized that several parameters may account for the nanocap size distribution including the amount of silica surface area exposed and the variation of gold colloid coverage on the exposed silica. For example, the variation in the height of the non-masked surface of the silica nanoparticles embedded in the PDMS matrix depends on the flow of the non-cured elastomer around the immobilized particles. Properties such as the viscosity of the liquid PDMS and its contact angle with the surface of the silica particle are important. Also, poor coverage of gold colloid will hinder the growth and the coalescence of the metal cap. A decrease in the diffusion mobility of gold colloidal particles near the surface of the PDMS film may reduce the attachment of the gold colloid on the available surface of the partially embedded silica nanoparticles. Since the aqueous solution does not wet the PDMS, the approach of the gold colloid toward the PDMS surface where the silica nanoparticles are embedded may be arrested, as may the gold deposition from solution onto the nanocap structures.

In order to examine the effect of the size distribution of the gold nanocaps on the plasmon resonance, additional calculations of the plasmon response of nanocaps were performed for gold nanocaps of various sizes. In FIG. 10a, theoretical extinction spectra are plotted for nanocaps with a core radius r=50 nm, a gold cap thickness t=12.5 nm, and various diameters d illuminated under normal incidence (θ=0°). As the diameter of the nanocap is increased, the long-axis dipole peak red shifts. Furthermore, the dependence of the plasmon resonance frequency on the cap diameter is approximately linear. The increase of the gold cap diameter while the gold thickness is kept constant represents an increase of the aspect ratio of the gold cap. This is associated with the red shift of the longitudinal mode of the plasmon. Similar results have been reported in investigations of other asymmetric gold nanoparticles such as nanorods. (See Link, S., Mohamed, M. B., and El-Sayed, M. A., “Simulation of the optical absorption spectra of gold nanorods as a function of their aspect ratio and the effect of the medium dielectric constant.” J. Phys. Chem. B, 103, 3073 (1999).) Therefore, it can be expected that the experimental spectra in FIG. 9b are a superposition of the longitudinal mode of the plasmon resonance for the different gold cap sizes that are present in the sample. Referring now to FIG. 10b, the results of fitting the experimental spectrum from FIG. 7a, θ=0°, with three theoretical spectra generated by assuming the nanocaps have a core radius r=50 nm, a gold cap thickness t=12.5 nm, and possess a distribution of diameters with d=25 nm, 55 nm, and 85 nm are shown. A variation of less than 15 nm in the height of the silica core protruding from the PDMS matrix before gold cap growth accounts for the distribution in the diameter of the nanocaps. The mean maximum height of this distribution of nanocap particles above the PDMS substrate is 14.9 nm, which is consistent with SEM and AFM observations.

As mentioned above, nanoparticles made according to the principles of the present invention find use in a variety of different applications, including components (such as sensors, dopants, surfactants, and writing media, i.e. electronic ink) manipulatable by applied static or frequency dependent electric, magnetic, or optical fields. Furthermore, nanoparticles made according to the principles of the present invention may be left in masking film so as to preserve the nanoparticles' structure and orientation, allowing them to be used as a tunable kit.

While the above description has discussed reduced symmetry nanoparticles such as nanoshells, it is contemplated that the present methods may also apply to the fabrication of more complex reduced symmetry nanostructures, such as metallodielectric or bimetallic amphiphilic rods and spheres. In addition, while the above embodiments showed one area of the nanoparticles masked off, it is contemplated that a number of areas on the nanoparticles may be masked in order to create additional complex shapes such as dimers, wherein the masked regions of the nanoparticles are modified to attach to each other.

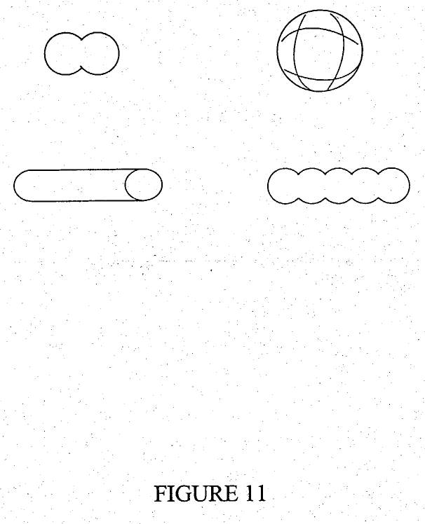

FIG. 11 shows a variety of complex reduced symmetry nanostructures made in accordance with the present invention. While PDMS elastomer has been described as a preferred masking material, any material which is substantially inert to the colloidal conducting solution and has sufficient flexibility allowing the nanoparticles to be removed from the masking material, may be used. Furthermore, in some embodiments, the masking material may be removed from the nanoparticle core by methods known to one skilled in the art, such as dissolution in appropriate solvents. Upon removal of the masking material, it is contemplated that the previously masked regions may be functionalized (e.g. additional metals may be reduced onto the nanoparticle core where the masking material had previously been).

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. For example, while the masked areas described comprised a glass slide and a polymeric film, any masking shape or configuration may be used. Additionally, while a dielectric or semiconducting core has been described in combination with a conducting shell, it is within the scope of the present invention to use other materials for both the core and shell. For example, nanoparticles having an oxidic or polymeric shell and suitable core made be made according to the principles of the present invention. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A method for producing an asymmetric nanoparticle from a nanoparticle core comprising:
(a) masking a portion of the nanoparticle core such that the nanoparticle has masked and unmasked regions;
(b) attaching conducting colloid material to the unmasked regions; and
(c) reducing additional conducting material onto the unmasked regions, such that a conducting partial shell covers the nanoparticle core, forming an asymmetric nanoparticle.

2. The method according to claim 1 wherein the nanoparticle core comprises a functionalized dielectric or semiconducting material.

3. The method according to claim 2 wherein the dielectric material is selected from the group consisting of silica, titania, polymethyl methacrylate, polystyrene, gold sulfide and macromolecules.

4. The method according to claim 2 wherein the semiconducting material is selected from the group consisting of CdSe, CdS and GaAs.

5. The method according to claim 1 wherein the conducting material comprises an organic or metallic conducting material.

6. The method according to claim 5 wherein the organic conducting material is selected from the group consisting of polyacetylene and doped polyanaline.

7. The method according to claim 5 wherein the metallic conducting material is selected from the group consisting of gold, silver, copper, platinum, palladium, lead, iron, and nickel.

8. The method according to claim 1 wherein the nanoparticle core is masked with a polymeric masking material.

9. The method according to claim 1 wherein the conducting partial shell covers approximately 10-90% of the nanoparticle.

10. The method according to claim 9 wherein the nanoparticle comprises a nanocap.

11. The method according to claim 9 wherein the nanoparticle comprises a nanocup.

12. The method according to claim 1 wherein the nanoparticle has a variable plasmon resonance.

13. The method according to claim 12 wherein the plasmon resonance is dependent on the orientation of the nanoparticle with respect to incident light.

14. An asymmetric nanoparticle comprising:
a nanoparticle core; and
a conducting partial shell,
wherein the conducting partial shell is formed by a method which includes masking one or more regions of the nanoparticle core.

15. A light detecting device comprising the nanoparticle of claim 14.

16. A chemical sensing device comprising the nanoparticle of claim 14.

17. A dopant in an optically active material comprising the nanoparticle of claim 14.

18. An electronic ink comprising the nanoparticle of claim 14.

19. A surfactant comprising the nanoparticle of claim 14.
